(19) United States
(12) Patent Application Publication
(10) Pub. No.: US 2003/0023731 A1
(43) Pub. Date: Jan. 30, 2003

(54) Mechanism for automatically determining signaling role and associated protocol of frame relay communication device

(75) Inventors: David Perkinson, Madison, AL (US); Gary Culp, Sommerville, AL (US); W. Stuart Venters, Huntsville, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Adtran, Inc., Huntsville, AL

(21) Appl. No.: 09/912,282

(22) Filed: Jul. 24, 2001

(51) Int. Cl. G06F 15/16

(52) U.S. Cl. 709/228; 709/220

(57) ABSTRACT

User participation in configuring parameters of a piece of frame relay communication equipment is eliminated by an automatic signaling role and protocol identification and configuration routine that is executed by the communication control processor of the frame relay communication equipment. The routine includes a precursor time out that effectively eliminates the undesirable likelihood of two or more devices reaching the same configuration. Once configured either as a switch or a user FRAD, the device is prevented from conducting any further polling or responding to polls by another device, so that the configuration cannot be altered, and the device is assured of complying with established telecommunications industry standards, such as Sprint frame relay certification.

### FIELD OF THE INVENTION

The present invention relates in general to digital communication systems and networks, and is particularly directed to a digital communication configuration scheme for a frame relay communication device, that is operative to automatically determine the signaling role and protocol of the device, and then configure the device for signaling type and protocol without user intervention.

### BACKGROUND OF THE INVENTION

Many users of digital communication networks, such as but not limited to financial, educational and governmental institutions, whose business activities rely upon vast amounts of archival storage and large main frame data processing systems, have traditionally employed legacy telecommunication protocols to transport data from one point to another. A reduced complexity diagram of a digital communication network is diagrammatically illustrated in FIG. 1, wherein a host/master data terminal 10 communicates over a dedicated data link 12 with a plurality of secondary/slave terminals 14.

With ongoing improvements in digital communication technology, telecommunication service providers currently prefer to offer their customers communication techniques, such as frame relay, that take advantage of their higher communication speeds and information processing capacities. Although frame relay provides for the creation of a network of permanent virtual circuits (PVCs) that enable the transport of any type of user data between remote sites, successful operation of a device coupled of a frame relay network requires that the communication equipment be properly configured (either as a switch or a frame relay access device (FRAD)), which has traditionally mandated participation by the end user. (By ‘properly configured’ is meant that the device will comply with established telecommunications industry standards, such as the frame relay certification requirements of U.S. Sprint Corporation.)

As the end user (customer) can be expected to be technically unskilled or incompetent, the more that is required of the customer in setting up the equipment, the greater is the likelihood of error in attempting to establish a link. Even in the case of a relatively small network, supplying all of the necessary configuration information translates into significant user participation to properly configure the device. From a user and supplier standpoint, the preferred installation should be no more than a ‘plug and play’ exercise.

### SUMMARY OF THE INVENTION

In accordance with the present invention, this substantial user participation requirement in properly configuring the operational communication parameters of a piece of frame relay communication equipment (either as a switch or as a user access device) is effectively eliminated by an automatic signaling role and protocol identification and configuration routine that may be readily incorporated into the supervisory control software employed by the device's communication control processor.

Since the possibility exists that another device may also be in the process of autoconfiguring itself, such as may occur upon start-up of a pair of interconnected devices in a laboratory test environment, after a power failure recovery, reset, etc., the autodetection and configuration routine of the invention initially waits a random time interval before attempting to execute a polling sequence of respectively different protocols for the purpose of receiving a response from another device. Since each device performs uses its own random number generator, there is minimal likelihood of two or more devices reaching the same configuration.

During the initial time-out interval, the routine is continuously looking for a poll from another device. If a poll is received during this interval, the device is then configured as a user FRAD, using the protocol information in the received packet, and the routine exits. Exiting the routine not only prevents polling by the present device, but also prevents the device from responding to any additional polls by other devices, so that the device configuration cannot be altered. This assures the autoconfigured device will pass Sprint frame relay certification.

If, at the conclusion of the random time out interval, no polling packet from another device has yet been received, the routine branches to a prescribed polling sequence, which steps through successive potential protocols that may be used to conduct frame relay communications with another device. At an initial step in the polling sequence, a polling message is transmitted using a preselected frame relay protocol, and containing a request for a full status reply to the polling message. If a response to the poll is accepted by another device within a prescribed response window, then the transmitting device is configured as a switch mode device using that protocol, and the routine exits. However, if no response to the poll is accepted by another device within the response window, then the device is configured for a different signaling protocol, and a new polling message is transmitted.

This sequential polling routine continues for all frame relay signaling protocols until the last protocol in the sequence has been used. If there has been no response to polling for the entire protocol sequence, the routine resets the random time out soft-counter is a new random number, and repeats. If a poll from another (network switch mode) device has been received during the polling sequence, then the device will configure itself as a FRAD, using the protocol information in the received packet, and the routine exits. On the other hand, if the new random time-out occurs without receiving a packet, the polling sequence is again executed as described above. The routine will eventually either receive a response from another device in the course of the polling sequence—and the device will become the switch—or the device will be polled by another (switch) device—and become the user.

### BRIEF DESCRIPTION OF THE DRAWINGS

FIG. 1 is a reduced complexity diagram of a legacy data communication network, in which a host/master terminal communicates over a dedicated synchronous data link with a plurality of secondary/slave terminals;

FIG. 2 is a reduced complexity diagrammatic illustration of a frame relay network architecture that is configured to provide for packetized data transport among respective pieces of frame relay terminal equipment serving a pair of user sites; and

FIG. 3 is a flow chart showing respective steps of the automatic frame relay device signaling role and protocol determination scheme of the present invention.

### DETAILED DESCRIPTION

Before describing in detail, the detection and configuration scheme of the present invention, it should be observed that the invention resides primarily in what is effectively an augmentation of the control software employed by the micro-controller of a frame relay network communication device, that has been coupled to a frame relay communication network. Execution of this modified control software enables both the signaling role and the associated protocol of the equipment to be automatically determined. The circuitry of the network and communication components of devices that couple the user equipments to the network are otherwise essentially unaffected.

Consequently, the configuration of these frame relay communication devices and the manner in which they are interfaced with other pieces of telecommunication equipment, including the frame relay network proper and user end terminals, have been illustrated in the drawings by readily understandable block diagrams, which show only those specific details that are pertinent to the present invention, so as not to obscure the disclosure with details which will be readily apparent to those skilled in the art having the benefit of the description herein. Thus, the block diagram illustrations of the Figures and associated flow chart are primarily intended to illustrate the major components of a frame relay network and processing sequence of the autodetection and configuration mechanism in a convenient functional grouping, whereby the present invention may be more readily understood.

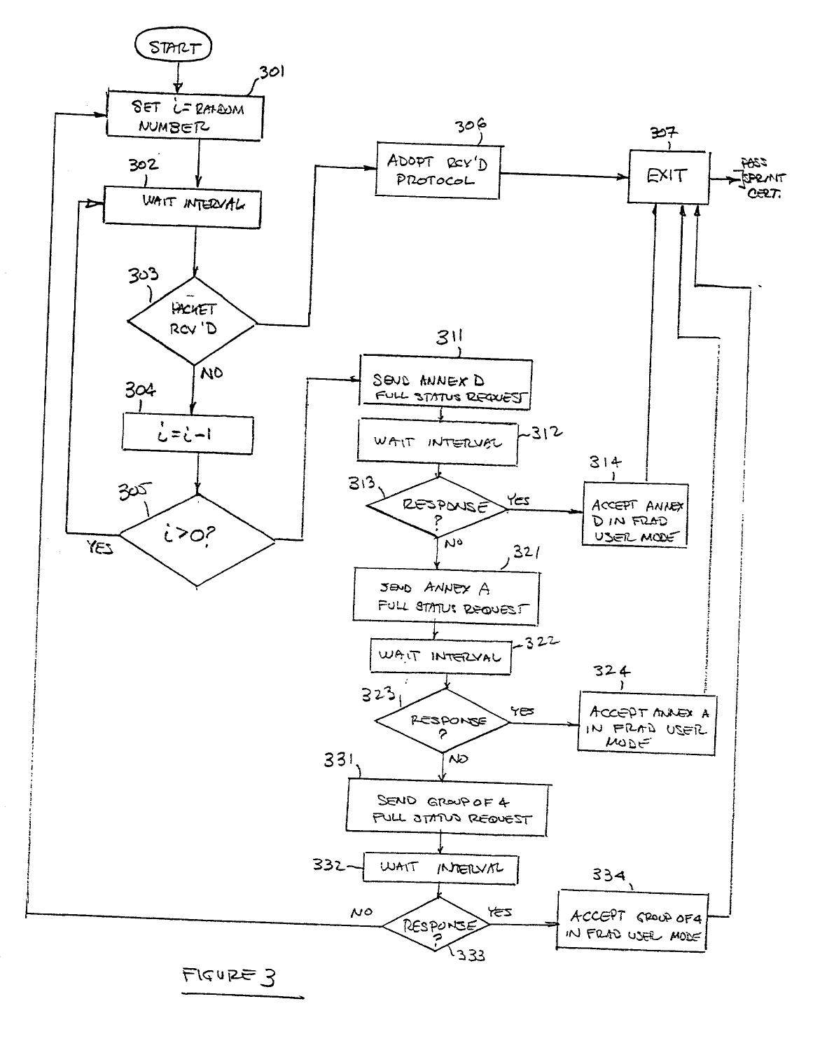

FIG. 2 is a reduced complexity diagrammatic illustration of a frame relay network architecture that is configured to provide for packetized data transport among respective pieces of frame relay terminal equipment serving a pair of user sites. While only two sites are shown in FIG. 2, it is to be understood that the invention is not limited thereto, but may be used with any number of pieces of equipment or sites. The illustration of a pair of sites (and associated user equipments) is simply to reduce the complexity of the drawings and attendant description.

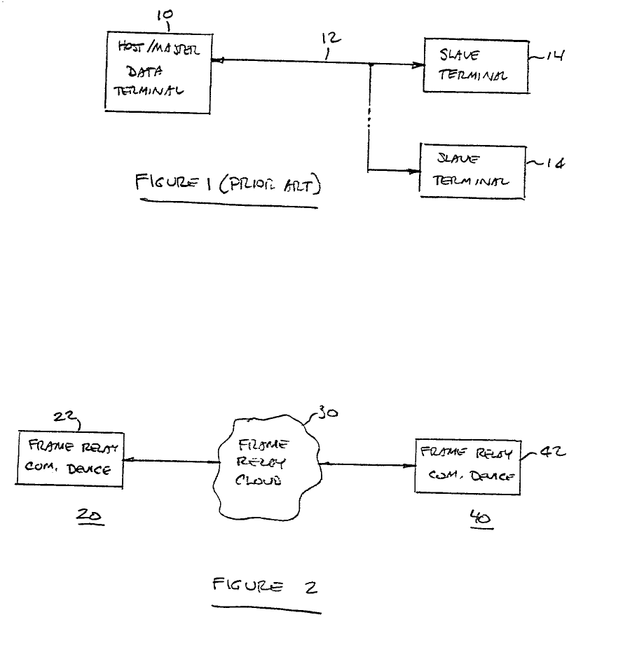

As shown in FIG. 2, the network comprises a first (west, as viewed in the Figure) user site 20 having a frame relay capable communication device 22 through which connectivity is to be provided to a frame relay network cloud 30. As a non-limiting example, each of the frame relay capable communication devices of FIG. 2 may comprise an Atlas 800^{PLUS} integrated access communication platform, manufactured by Adtran Inc., Huntsville, Ala. Also coupled to the network cloud is a second (east, as viewed in the Figure) user site 40 having a frame relay communication device 42. Each of the devices 22 and 42 employs an associated data link connection identifier to create logical connections between end points of the network. In the simplified frame relay network architecture of FIG. 2, the user site 20 effectively may be considered to be analogous to the host/master terminal 10 of FIG. 1, while user site 40 may correspond to the secondary/slave terminals 14 of FIG. 1.

As pointed out above, successful (e.g., ‘sprint-certifiable’) frame relay connectivity between a respective frame relay capable device and the frame relay network has customarily required that each network device (here—user devices 22 and 42) be properly configured (by the customer) in association with their respective signaling role functions and using the appropriate frame relay signaling protocol. To obviate the above-mentioned problems associated with this requirement, the invention modifies the communication control software employed by the processors of each of the devices, so that they may interactively and automatically determine their signaling roles and associated communication protocols, in a manner that is a transparent ‘don't care’ to the user/installer of the equipment.

The automatic frame relay device signaling role and protocol determination scheme of the present invention will now be described with reference to the flow chart of FIG. 3. As pointed out above, in order to effectively prevent more than one device from autoconfiguring itself to be the same type of device as another device that happens to be simultaneously in the process of autoconfiguring itself (which could occur, for example, after recovery (reset) from a power failure, on start-up, etc.), the autodetection and configuration routine of the invention initially waits a random time interval (for a poll from another device) before proceeding in switch mode, wherein it polls the network for a response from another device. Since, each device performs this initial delay step using its own random number generator, there is minimal likelihood of simultaneous polling by two or more devices.

For this purpose, as an initial step in the routine, shown at step 301, a soft-counter is set to a random value. Then, after a prescribed delay or ‘wait’ interval in step 302, the routine transitions to query step 303, to inquire whether a packet has been received from another (polling) device, that has already begun its polling. If the answer to query step 303 is YES, indicating that the device of interest has been polled by another device, then the device is configured in step 306 as a user FRAD, using the protocol information in the received packet, and the routine exits at step 307. Since exiting the routine at step 307 not only prevents polling by the present device, but also prevents the device from responding to any additional polls by other devices, the device configuration cannot be altered, thereby ensuring that the autoconfigured device will pass Sprint frame relay certification.

If, after the wait interval of step 302, the answer to query step 303 is NO (indicating that no polling packet from another (switch) device has yet been received), the contents of the soft-counter as initially set in step 301 are modified (here decremented) in step 304. Next, in query step 305, a determination is made as to whether the contents of the soft-counter have reached a prescribed value (e.g., been decremented to zero) in association with the termination of the random time out interval. If the answer to query step 305 is YES, indicating that the random time-out (polling-precursor) interval defined by the random count value of step 301 has not yet expired, the routine loops back to the ‘wait’ interval of step 302, and the sequence described above is repeated.

Should the random interval timer sequence of steps 301-305 expire prior to a packet being received (the answer to query step 305 is NO), then the routine branches from step 305 to a prescribed polling sequence which steps through successive potential protocols that may be used to conduct frame relay communications with another device. At an initial step in the polling sequence, shown at step 311, a polling message is transmitted using a preselected frame relay protocol, shown as ANNEX D, and containing a request for a full status reply to the polling message. Next, after a prescribed (e.g., ten second) wait interval step 312, the routine transitions to query step 313, to inquire whether a response to the poll of step 311 has been received. If the answer to query step 313 is YES, indicating that the transmitted protocol has been accepted by another device, then in step 314, the device is configured as a switch mode device using ANNEX D protocol, and the routine exits at step 307. As noted earlier, exiting the routine once the device has been configured prevents further polling by the present device, and also prevents the device from responding to any polls by other devices, so that the device configuration cannot be altered, and ensuring that the autoconfigured device will pass Sprint frame relay certification.

If the answer to query step 313 is NO, indicating that the transmitted (ANNEX D) protocol was not been accepted by another device during the polling interval of step 312, the routine transitions to step 321, wherein the device is configured for a different signaling protocol, shown as ANNEX A, and a new polling message is transmitted, again containing a request for a full status reply. After wait interval step 322, the routine transitions to query step 323, to inquire whether a response to the (ANNEX A) poll of step 321 has been received. If the answer to query step 323 is YES, indicating that the transmitted protocol has been accepted by a (FRAD) device, then in step 324, the polling device is configured for switch mode signaling using ANNEX A protocol, and the routine exits at step 307.

If the answer to query step 323 is NO, indicating that the transmitted ANNEX A protocol was not been accepted by another device during the polling interval of step 322, the routine transitions to step 331, wherein the polling device is configured for another type of signaling protocol, shown as GROUP OF 4, and a new polling message is transmitted containing a request for a full status reply. After wait interval step 332, the routine transitions to query step 333, to inquire whether a response to the (GROUP OF 4) poll of step 331 has been received by another (FRAD) device. If the answer to query step 333 is YES, indicating that the transmitted (GROUP OF 4) protocol polling message has been accepted by another device, then in step 334, the polling device is configured for switch mode signaling using GROUP OF 4 protocol. The routine then exits at step 307.

This sequential polling routine continues for all frame relay signaling protocols until the last protocol in the sequence (GROUP OF 4, in the present example) has been exercised. If there has been no response to polling for the entire protocol sequence (the answer to the last poll response query step (step 333 in the present example) is NO), the routine branches back to step 301, wherein the random time out soft-counter is reset to a new random number, and the routine described above is repeated. If a poll from another (network switch mode) device has been received during the polling sequence, then the answer to query step 303 will be YES, and the device will configure itself in step 306 as a FRAD, using the protocol information in the received packet, and the routine exits at step 307. On the other hand, if the time-out occurs without receiving a packet, the polling sequence is again executed as described above. Thus, the routine will eventually either receive a response from another device in the course of the polling sequence—and the device will become the switch—or the device will be polled by another (switch) device—and become the user.

As will be appreciated from the foregoing description, the signaling role and protocol identification and configuration mechanism of the present invention not only obviates the need for user participation in configuring the operational communication parameters of a piece of frame relay communication equipment, but does so in a manner that effectively eliminates the undesirable likelihood of two or more devices reaching the same configuration. Moreover, once the device has been configured either as a switch or a user FRAD, the autoconfiguration routine is immediately terminated, preventing the device from any further polling or from responding to polls by another device. Thus, the configuration cannot be altered, and the device is assured of complying with established telecommunications industry standards, such as Sprint frame relay certification.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

WHAT IS CLAIMED

1. For use with a frame relay network through which virtual circuits are established to enable communications between terminal equipments, a respective terminal equipment being coupled to said frame relay network by way of a processor-controlled frame relay communication device, a processor-executed autoconfiguration routine for automatically configuring said frame relay communication device for operation with said frame relay network comprising the steps of:
(a) during a random time interval, monitoring said frame relay network for a poll from another frame relay communication device;
(b) in response to receiving a poll from another frame relay communication device during the random time interval of step (a), automatically configuring said frame relay communication device as a frame relay access device that uses the signaling protocol in the received poll and exiting said routine; but
(c) in response to the expiration of said random time interval without having received a poll from another frame relay communication device, transmitting one or more polling messages, using different signaling protocols, as necessary, over said frame relay network; and
(d) in response to receiving a response from another frame relay communication device to a polling message transmitted in step (c), automatically configuring said frame relay communication device as a switch mode access device that uses the signaling protocol of the polling message to which a response was received, and exiting said routine.

2. The processor-executed autoconfiguration routine according to claim 1, further comprising the step of:
(e) in response to failing to receive a response from another frame relay communication device to any polling message transmitted in step (c), repeating steps (a)-(d) as necessary, until either a poll or a response to a polling message is received from another frame relay communication device, and configuring said frame relay communication device in accordance with the signaling protocol of the received poll or response.

3. The processor-executed autoconfiguration routine according to claim 2, wherein step (e) comprises repeating steps (a)-(d) using a different random time interval.

4. The processor-executed autoconfiguration routine according to claim 1, wherein step (c) comprises transmitting a respective polling message using a respective signaling protocol and waiting for a response thereto during a prescribed time interval and, in response to failing to receive a response to said respective polling message during said prescribed time interval, transmitting a further polling message using a further signaling protocol.

5. The processor-executed autoconfiguration routine according to claim 4, wherein said respective signaling protocol comprises a selected one of ANNEX D, ANNEX A and GROUP OF 4 signaling protocols, and wherein said further signaling protocol comprises a selected other of said ANNEX D, ANNEX A and GROUP OF 4 signaling protocols.

6. An automatic signaling role and protocol identification and configuration routine that is adapted to be executed by a communications control processor of a frame relay communication device through which frame relay communications may be established with a frame. relay network comprising the steps of:
(a) prior to attempting any polling over said frame relay network, establishing a random time interval, during which said frame relay network is monitored for a poll from another frame relay communication device; and
(b) in response to receiving a poll from another frame relay communication device during said random time interval of step (a), automatically configuring said frame relay communication device as a frame relay access device that uses the signaling protocol identified in the received poll and exiting said routine.

7. The automatic signaling role and protocol identification and configuration routine of claim 6, further comprising the step of:
(c) in response to the expiration of said random time interval without having received a poll from another frame relay communication device, transmitting one or more polling messages, using different signaling protocols, as necessary, over said frame relay network, and automatically configuring said frame relay communication device as a switch mode access device using the signaling protocol of the polling message to which a response to a polling message was received, and exiting said routine.

8. The automatic signaling role and protocol identification and configuration routine of claim 7, further comprising the step of:
(d) in response to failing to receive a response from another frame relay communication device to any polling message transmitted in step (c), repeating steps (a)-(c) as necessary, until either a poll or a response to a polling message is received from another frame relay communication device, and configuring said frame relay communication device in accordance with the signaling protocol of the received poll or response.

9. The automatic signaling role and protocol identification and configuration routine of claim 8, wherein step (d) comprises repeating steps (a)-(c) using a different random time interval.

10. The automatic signaling role and protocol identification and configuration routine of claim 8, wherein step (c) comprises transmitting a respective polling message using a respective signaling protocol and waiting for a response thereto during a prescribed time interval and, in response to failing to receive a response to said respective polling message during said prescribed time interval, transmitting a further polling message using a further signaling protocol.

11. The automatic signaling role and protocol identification and configuration routine of claim 9, wherein said respective signaling protocol comprises a selected one of ANNEX D, ANNEX A and GROUP OF 4 signaling protocols, and wherein said further signaling protocol comprises a selected other of said ANNEX D, ANNEX A and GROUP OF 4 signaling protocols.
